(19) United States
(12) Patent Application Publication
(10) Pub. No.: US 2008/0319606 A1
(43) Pub. Date: Dec. 25, 2008

(54) VEHICLE ROLLOVER DETECTION AND PREVENTION SYSTEM

(76) Inventors: Frederick O. Fortson, Whitmore Lake, MI (US); Chad Lehner, Howell, MI (US); John Svinicki, Jackson, MI (US); Anu Gupta, Burgettstown, PA (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/033,507

(22) Filed: Feb. 19, 2008

Related U.S. Application Data
(60) Provisional application No. 60/890,558, filed on Feb. 19, 2007.

(51) Int. Cl. G06F 7/00; B60Q 1/00

(52) U.S. Cl. 701/35; 701/29; 340/438

(57) ABSTRACT

An intelligent system and method detects and prevents vehicle rollover conditions. An accelerator determines vehicle speed and lateral G force, a processor computes the center of mass of the vehicle by correlating the lateral G force produced while the vehicle is turning, and an alert that is activated if the speed is exceeded or if the turn radius is reduced beyond safety limits indicative of potential rollover of the vehicle. The preferred embodiment further includes a gyroscope operative to sense lateral yaw rate excursions of the vehicle, enabling the processor to correlate the yaw rate excursions at a given speed with the lateral G forces produced while the vehicle is turning. The accelerator may further be operative to determine vertical acceleration at a given speed along a third axis, and augment rollover alarm conditions on rough road surfaces. The processor may additionally be operative to compute the absolute maximum lateral angle of vehicle stability for a given center of mass, and trigger the alert if this value is approached during vehicle operation or when vehicle speed is zero.

### REFERENCE TO RELATED APPLICATION

This application claims priority from U.S. Provisional Patent Application Ser. No. 60/8890,558, filed Feb. 19, 2007, the entire content of which is incorporated herein by reference.

### FIELD OF THE INVENTION

This invention resides in a microprocessor-controlled, self-calibrating rollover detection and alert system. The system actively measures vehicle roll dynamics to provide a visual and audio warning to the operator that is proportional to vehicle instability conditions whether the vehicle is at rest or in motion. Other features are provided as set forth herein below.

### BACKGROUND OF THE INVENTION

The advantages of vehicle rollover detection have long been recognized. According to U.S. Pat. No. 6,055,472, in order to allow for a timely and reliable recognition of a rollover event of a vehicle, the angular velocities of the vehicle about the yaw axis, the roll axis, and the pitch axis are measured by way of respective rotation rate sensors. A rollover event is signaled as having been detected if an angular velocity exceeds a definable threshold.

U.S. Pat. No. 6,496,763 describes a system for detecting imminent or occurring rollovers in a vehicle having at least one rollover sensor for detecting a vehicle rollover and for emitting a corresponding signal. At least one rotational wheel speed sensor is provided which emits a signal corresponding to the respective rotational wheel speed to a control unit which is indirectly or directly connected with the at least one rollover sensor. The control unit is constructed such that a triggering signal can be generated for a safety system on the basis of the rollover signal, talking into account the at least one rotational wheel speed signal.

In U.S. Pat. No. 7,057,503, a roll angular velocity sensor and a lateral velocity sensor are operatively coupled to a processor, which generates a signal for controlling a safety restraint system responsive to measures of roll angular velocity and lateral velocity. In one embodiment, the processor delays or inhibits the deployment of the safety restraint system responsive to a measure responsive to the measure of lateral velocity, either alone or in combination with a measure of longitudinal velocity. In another embodiment, a deployment threshold is responsive to the measure of lateral velocity. The lateral velocity may be measured by a lateral velocity sensor, or estimated responsive to measures of lateral acceleration, vehicle turn radius, and either longitudinal velocity or yaw angular velocity, wherein the turn radius is estimated from either a measure of steering angle, a measure of front tire angle, or measures of forward velocity from separate front wheel speed sensors.

U.S. Pat. No. 7,333,884 describes a rollover detection system for a vehicle that comprises at least one sensor for the detection of the angle of rotation of the vehicle and/or at least one angular rate sensor. An electronic control device connected to the sensors as well as at least one safety device which can be activated via the control device in the event of a rollover scenario detected with reference to the sensor data. At least one irreversible safety device and at least one reversible safety device are provided. The control device distinguishes between at least one stage of a lower degree of severity and at least one stage of a higher degree of severity of the rollover scenario in the detection of a respective rollover scenario with reference to the sensor data in order to activate at least one reversible safety device in the case of a lower degree of severity and to activate at least one irreversible safety device in the case of a higher degree of severity.

### SUMMARY OF THE INVENTION

This invention resides in an intelligent system and method for detecting and hopefully preventing vehicle rollover conditions. The system includes an accelerator operative to determine vehicle speed and lateral G force, a processor for dynamically computing the center of mass of the vehicle by correlating the lateral G force produced while the vehicle is turning, and an alert that is activated if the speed is exceeded or if the turn radius is reduced beyond safety limits indicative of potential rollover of the vehicle. The preferred embodiment further includes a gyroscope operative to sense lateral yaw rate excursions of the vehicle, enabling the processor to correlate the yaw rate excursions at a given speed with the lateral G forces produced while the vehicle is turning.

The accelerator may further be operative to determine vertical acceleration at a given speed along a third axis, and augment rollover alarm conditions on rough road surfaces. The processor may additionally be operative to compute the absolute maximum lateral angle of vehicle stability for a given center of mass, and trigger the alert if this value is approached during vehicle operation or when vehicle speed is zero.

In the preferred embodiment, the accelerometer is a three-axis accelerometer, and the accelerometer and gyro may both be implemented with Micro-Electro-Mechanical Systems (MEMS) technology. The alert may be visual or audible. The system may further include a memory for storing a digital record of the rollover event. An optional CAN network interface that allows the system to communicate as a node on a wired CAN network or as a full CAN network controller in charge of all of the nodes on the network. Circuitry may be included for communicating over a secure wireless network, including a secure wireless mesh network.

A real-time clock may be used for keeping local time and for providing time stamping for data acquisition and control operations. A global positioning satellite (GPS) interface may be included for positional and/or time data.

### BRIEF DESCRIPTION OF THE DRAWING

FIG. 1 is a block diagram depicting the preferred embodiment of the invention.

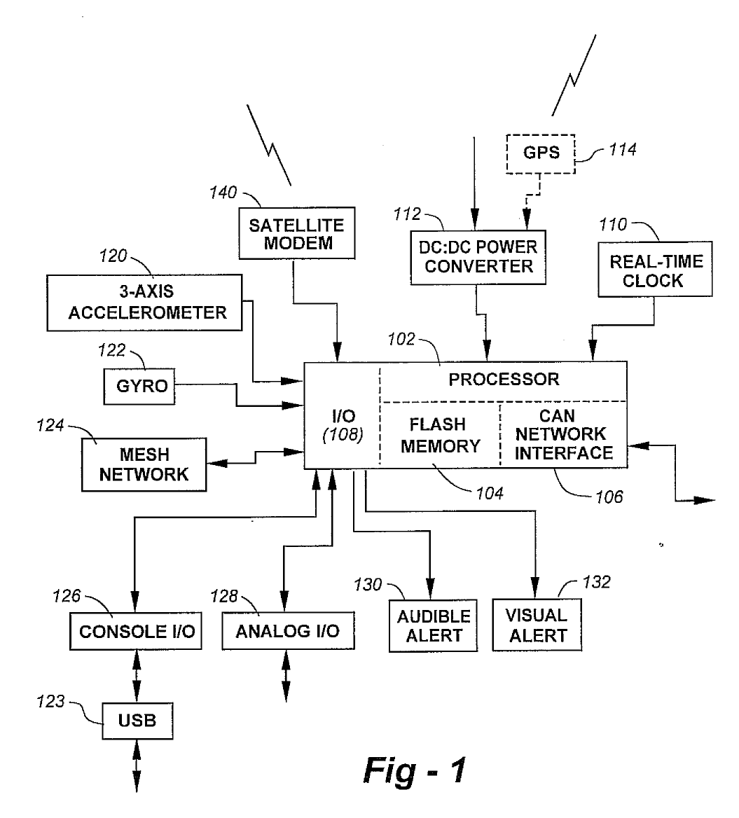

### DETAILED DESCRIPTION OF THE INVENTION

Referring to the FIGURE, the system employs a three-axis accelerometer 120 and a gyro 122 to sense incipient rollover conditions during the operation of a vehicle. Both are preferably implement using Micro-Electro-Mechanical Systems (MEMS) technology. As dynamic rollover conditions are detected, a visual alert 132 and audio warning 130 are delivered to the vehicle occupants, and a digital record of the event is captured in on-board FLASH memory 104 for post-event analysis. Audio warnings are provided as voice announcements or as an audio tone alarm from a built-in amplified speaker. An ultrabright 3-Watt light-emitting diode (LED) provides visual alerts. The system is entirely self-contained, and does not require any modification to the vehicle for proper installation and operation.

Computation of data input from the accelerometer 120 and gyro 122 are performed by processor 102 to determine the center of mass of the vehicle during operation. The X and Y axes of the accelerometer performs the function of vehicle speed computation as well as lateral G force measurement, respectively. Vertical acceleration measured at the Z axis is used to provide an indicator of road surface conditions at a given speed, which may be used to augment rollover alarm conditions on rough road surfaces. The gyro 122 is used to sense lateral yaw rate excursions along the vehicle's vertical axis.

The system dynamically computes the center of mass of the vehicle by correlating data from the yaw rate sensor at a given speed with lateral G forces produced while the vehicle is turning. For a given center of mass, the speed at which a vehicle may be safely driven while executing a turn is computed and a warning is delivered to the operator if such speed is exceeded or if the turn radius is reduced beyond safety limits.

Additionally, the absolute maximum lateral angle of vehicle stability is monitored for a given center of mass and the system warnings are triggered if this value is approached during vehicle operation or when vehicle speed is zero. All alert conditions are fully programmable and may be adjusted for safety margins as desired.

Dynamic computation of rollover conditions also performed for a stopped vehicle, as would be the case where a vehicle is ‘parked’ at an angle on a hillside and heavy equipment is loaded on top of the vehicle. The system measures the oscillating sway of the vehicle as the center of mass is raised and determines if safe loading conditions have been exceeded.

The processor 102 is preferably implemented with a microprocessor unit that is optimized for portable, vehicular and other applications requiring low current consumption and high performance. Such microprocessor unit incorporates a number of useful peripherals including high speed analog to digital converters, a CAN network interface 106, serial peripheral interfaces, counter/timers, on board FLASH 104 and RAM, and low power sleep and stop modes.

Power supply circuitry incorporates over voltage and over current protection devices as well as in line ferrite beads and chokes to provide clean power to the internal circuitry even under typically harsh vehicle power systems. A DC/DC power converter 112 enables uninterrupted operation from 9 to 36 Volt electrical systems. The system is able to operate with an internally mounted backup battery option to provide continuous operation, even when the vehicle supply is turned off or inoperable.

The system uses a real-time clock (RTC) 110 for keeping local time and providing time stamping for data acquisition and control operations. The RTC can be synchronized with an attached optional GPS module 114 for enhanced accuracy. The RTC then will provide a highly accurate time base for the system in the event of a loss or jamming of GPS signal.

The system has optional support for the two most widely used vehicle networks for heavy equipment, truck and military vehicle use. Optional J1939 CAN network expansion 106 allows the system to communicate as a node on a wired CAN network or as a full CAN network controller in charge of all of the nodes on the network. The system permits operation as a stand-alone CAN network with Solidica Pantheon sensors in vehicles with existing J1939 networks, as well as permitting the easy installation of a new J1939 CAN network as an upgrade retrofit for vehicles not already so equipped. Traction and stability control modules may easily accept accelerometer and gyro data from the system, thereby reducing overall system cost and increase vehicle safety and reliability.

The system includes a GPS core 114 for direct connection to a GPS antenna through a rear mounted SMA RF connector to provide positional and time data derived from the constellation of GPS satellites in Earth orbit. The system is able to acquire GPS fix in as little as 30 seconds from power on. GPS positional data and time data is available for on system use as well as broadcast over J1939 using standard protocols to provide GPS data to other nodes on the network.

The console I/O section includes a high-speed USB 2.0 device interface 123 to directly connect to an optional computer for control, data acquisition, and data base applications. When used in conjunction with Solidica's Pantheon Windows® application, the system can save all vehicle network and wireless network sensor data to a host PC for forensic analysis of rollover events and warnings in real time. Additionally, Pantheon settings and program information may be set up using this software when connected to a PC over the supplied USB part.

The analog option includes eight channels of high speed, 12 bit analog data acquisition that may be used for internal operations or streamed to external devices. The analog I/O interface 128 is able to directly connect to any vehicle subsystem, including knobs, switches, dials and sensors such as Fuel Level and Speed without requiring any special interface circuitry or signal conditioning.

The system is optionally able to communicate with vehicle sensors over a secure 802.15.4 wireless mesh network, as well as communicate off vehicle to enterprise level Autonomic Logistics and Sense and Respond systems using an optional 802.11g secure wireless network interface 124. Additionally, the 802.15.4 secure wireless interface allows multiple vehicles to communicate with each other over a secure Macro Mesh network to pass text and voice messages, as well as vehicle system health and status information.

The satellite interface option allows a direct connection to common satellite radio systems such as Orbcomm and Iridium. One satellite interface 140 may be shared with all vehicles in a Solidica Macro Mesh Network.

The power supply section 112 features a 3 Volt Low Dropout Linear regulator for direct connection to an unregulated DC supply or battery pack for low power operation. The LDO is able to operate the sensor down to 1.8 Volts.

A digital radio provides the physical link layer for the Wireless Sensor Protocol used in the Pantheon system. Able to operate in noisy, harsh and mobile environments, the '192 incorporate encrypted direct sequence and frequency hopping spread spectrum technology for interference rejection, noise immunity and security from jamming or eavesdropping. The RF I/O strip engineered into the Solo sensor provides a direct connection to 50-Ohm low loss coaxial cable for direct connection to any 2.4 GHz antenna systems.

The Analog Input section 128 provides a direct connection to sensors such as RID temperature sensors and discrete voltage or current operated DC sensor devices and controls. Included signal conditioning allows for up to two externally mounted sensor devices. A system power supply monitor allows for external monitoring of power supply source Voltage such as may be used to predict battery failure and charge/discharge characteristics.

The three-axis MEMS accelerometer is implemented in the system. In addition to rollover detection functions, it may also be used for vibration and inertial sensor applications such as dead reckoning, shots fired detection, hit detection, road quality analysis, vibration analysis for prognostics and diagnostics of moving parts and assemblies, navigation and other advanced applications. The accelerometer may be put in “sleep mode” for ultra low power operation when continuous vibration monitoring is not required.

### Ride Harshness and Maintenance Prognostics Sensor

Leverages the system architecture and functionality aforementioned in the disclosure—including microprocessor, gyroscopes and accelerometers. This on-board data aggregation and storage sensor monitors/gathers vibration, impact and harshness data for nearly any vehicle. It enables correlation of ride harshness factor(s) to specific vehicle sub-system failure and long-term maintenance scenarios. Further, this device:
Operates as a smart odometer by enhancing the data related to the distance traveled by the vehicle with the impact of such distance on the vehicle
Assigns a harshness index value to the vehicle platform, and also logs the aggregate result of such index within itself for subsequent download and analysis.
Creates a baseline for platform life-cycle management and prognostication.
Supports condition-based maintenance
Improves preventive maintenance and life-cycle management
Reduces unscheduled break-downs and down-times for repairs.

We claim:

1. A system for detecting a vehicle rollover condition, comprising:
an accelerator operative to determine vehicle speed and lateral G force;
a processor for dynamically computing the center of mass of the vehicle by correlating the lateral G force produced while the vehicle is turning; and
an alert that is activated if the speed is exceeded or if the turn radius is reduced beyond safety limits indicative of potential rollover of the vehicle.

2. The system of claim 1, further including:
a gyroscope operative to sense lateral yaw rate excursions of the vehicle; and
wherein the processor is further operative to correlate the yaw rate excursions at a given speed with the lateral G forces produced while the vehicle is turning.

3. The system of claim 1, wherein:
the accelerator is further operative to determine vertical acceleration at a given speed along a third axis; and
the processor is further operative to augment rollover alarm conditions on rough road surfaces.

4. The system of claim 1, wherein the processor is further operative to:
compute the absolute maximum lateral angle of vehicle stability for a given center of mass; and
trigger the alert if this value is approached during vehicle operation or when vehicle speed is zero.

5. The system of claim 1, wherein the accelerometer is a three-axis accelerometer.

6. The system of claim 1, wherein the accelerometer is implemented with Micro-Electro-Mechanical Systems (MEMS) technology.

7. The system of claim 1, wherein the gyro is implemented with Micro-Electro-Mechanical Systems (MEMS) technology.

8. The system of claim 1, wherein the alert is a visual alert.

9. The system of claim 1, wherein the alert is an audible alert.

10. The system of claim 1, further including a memory for storing a digital record of the rollover event.

11. The system of claim 1, further including a CAN network interface that allows the system to communicate as a node on a wired CAN network or as a full CAN network controller in charge of all of the nodes on the network.

12. The system of claim 1, further including circuitry for communicating over a secure wireless network.

13. The system of claim 1, further including circuitry for communicating over a secure wireless mesh network.

14. The system of claim 1, further including a real-time clock for keeping local time and for providing time stamping for data acquisition and control operations.

15. The system of claim 1, further including a global positioning satellite (GPS) interface providing positional or time data.
